(19) United States
(12) Patent Application Publication
(10) Pub. No.: US 2013/0243323 A1
(43) Pub. Date: Sep. 19, 2013

(54) IMAGE PROCESSING APPARATUS, IMAGE PROCESSING METHOD, AND STORAGE MEDIUM

(71) Applicant: OLYMPUS CORPORATION, Tokyo (JP)

(72) Inventor: Yoichi Yaguchi, Hino-shi (JP)

(73) Assignee: OLYMPUS CORPORATION, Tokyo (JP)

(21) Appl. No.: 13/889,883

(22) Filed: May 8, 2013

Related U.S. Application Data
(63) Continuation of application No. PCT/JP2011/070503, filed on Sep. 8, 2011.

(30) Foreign Application Priority Data
Nov. 9, 2010 (JP) 2010-251110

(51) Int. Cl. G06K 9/00

(52) U.S. Cl. CPC G06K 9/00523
USPC 382/173; 382/195

(57) ABSTRACT

An image processing apparatus which recognizes a main subject from an image to be recognized includes an image feature value generating module, an extra-image feature value acquiring module, a scene recognition module, a scene and main-subject correlation storage module, and a main subject recognition module. The scene recognition module recognizes scene information of the image, based on an image feature value generated by the image feature value generating module and an extra-image feature value acquired by the extra-image feature value acquiring module. The main subject recognition module estimates main subject candidates, by using the recognized scene information and correlation between scene information and main subjects typical of the respective scene information stored in the scene and main-subject correlation storage module.

### CROSS REFERENCE TO RELATED APPLICATIONS

This application is a Continuation Application of PCT Application No. PCT/JP2011/070503, filed Sep. 8, 2011 and based upon and claiming the benefit of priority from prior Japanese Patent Application No. 2010-251110, filed Nov. 9, 2010, the entire contents of all of which are incorporated herein by reference.

### BACKGROUND OF THE INVENTION

1. Field of the Invention

The present invention relates to an image processing apparatus and an image processing method, which recognizes a main subject from an image, and a storage medium which stores a program that causes a computer to execute a process of the image processing apparatus.

2. Description of the Related Art

There is a demand for recognition of a subject in an image, to use it for various image processing and image recognition.

Generally, configured are image processing apparatuses which estimate a subject based on an image feature value by preparing data (teacher data) on correlation between an image and a subject in the image is prepared for a large number of images, and by learning the teacher data.

However, since there are many various subjects, a plurality of subjects have similar image feature values, and clusters thereof overlap each other. When clusters of a plurality of subject overlap, it is difficult to distinguish the subjects from each other.

Thus, U.S. Patent Application Publication No. 2009/0059027 presents a method, which relates to improvement in accuracy of face detection processing. The method correlates sound information generated from a main subject with the main subject, and records it in a dictionary. In this method, sound which is generated from a main subject is collected, and the main subject is detected based on not only image information but also sound information, which is information outside the image, to improve accuracy of recognition of the main subject.

### BRIEF SUMMARY OF THE INVENTION

According to a first aspect of the invention, there is provided an image processing apparatus which recognizes a main subject from an image to be recognized, comprising:

an image feature value generating module configured to generate an image feature value calculated from the image to be recognized;

an extra-image feature value acquiring module configured to acquire an extra-image feature value obtained from extra-image information;

a scene recognition module configured to recognize scene information of the image, based on the image feature value and the extra-image feature value;

a scene and main-subject correlation storage module configured to store correlation between scene information and main subjects typical of the respective scene information; and

a main subject recognition module configured to estimate main subject candidates, by using the scene information recognized by the scene recognition module and the correlation stored in the scene and main-subject correlation storage module.

According to a second aspect of the invention, there is provided an image processing method of recognizing a main subject from an image to be recognized, comprising:

generating an image feature value calculated from the image to be recognized;

acquiring an extra-image feature value obtained from extra-image information;

recognizing scene information of the image, based on the image feature value and the extra-image feature value; and

estimating main subject candidates, by using correlation between scene information items stored in advance and main subjects typical of the scene information items, and the recognized scene information.

According to a third aspect of the invention, there is provided a recording medium non-transitory storing a program configured to control a computer of an image processing apparatus which recognizes a main subject from an image to be recognized, wherein the recording medium non-transitory stores a program causing the computer to execute:

an image feature value generation step of generating an image feature value calculated from the image to be recognized;

an extra-image feature value acquisition step of acquiring an extra-image feature value obtained from extra-image information;

a scene recognition step of recognizing scene information of the image, based on the image feature value and the extra-image feature value;

a scene and main-subject correlation storing step of storing correlation between scene information and main subjects typical of the respective scene information; and

a main subject recognition step of estimating main subject candidates, by using the scene information recognized by the scene recognition module and the correlation stored at the scene and main-subject correlation storing step.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating an example of configuration of an image processing apparatus according to an embodiment of the present invention; and

FIG. 2 is a flowchart for explaining operation of an operating module in the image processing apparatus of FIG. 1.

### DETAILED DESCRIPTION OF THE INVENTION

An embodiment will be explained hereinafter with reference to drawings.

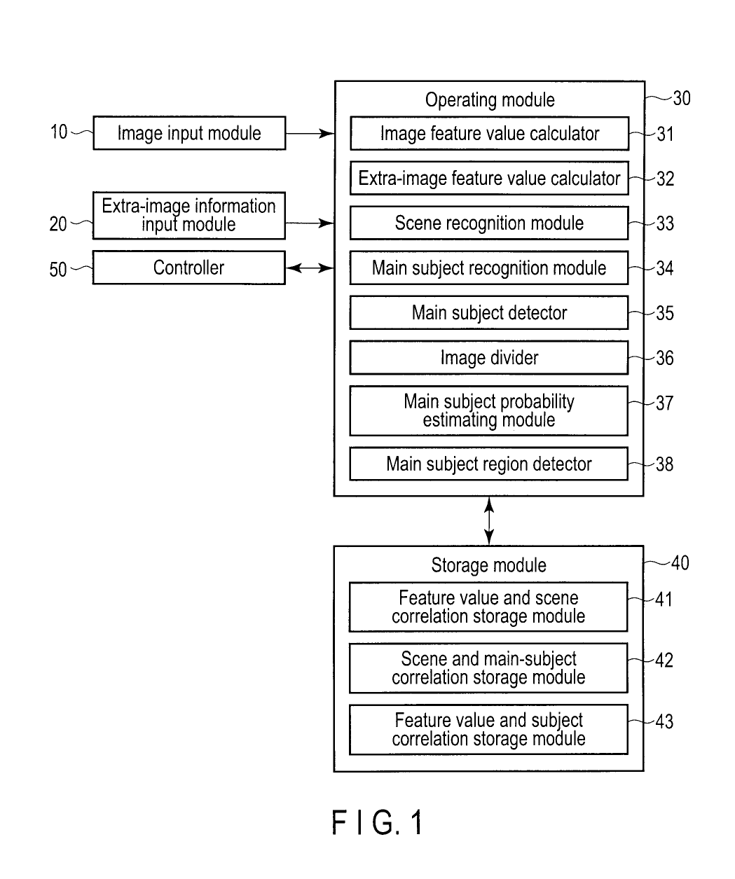

As illustrated in FIG. 1, an image processing apparatus according to an embodiment of the present invention includes an image input module 10, an extra-image information input module 20, an operating module 30, a storage module 40, and a controller 50.

In the above structure, the image input module 10 inputs images. When the image processing apparatus is integrated into an imaging apparatus which has an imaging function, such as a digital camera and an endoscope, the image input module 10 can be configured as an imaging module which includes an optical system, an imager (such as a CMOS sensor and a CCD sensor), and a signal processing circuit that generates image data from an output signal of the imager. When the image processing apparatus is configured as an apparatus which is separated from the above imaging apparatus, the image input module 10 is configured as an image reading module which reads images through an image storage medium or a network. Even when the image processing apparatus is integrated into an imaging apparatus, the image input module 10 may be configured as an image reading module, which reads images from the outside of the imaging apparatus, as a matter of course.

The extra-image information input module 20 inputs information other than images. When the image processing apparatus is integrated into an imaging apparatus, the extra-image information input module 20 can be configured as an information obtaining module which obtains information that can be obtained in imaging by the imaging apparatus, as extra-image information. When the image processing apparatus is configured as an apparatus which is separated from the above imaging apparatus, the extra-image information input module 20 is configured as an image reading module which reads extra-image information that is correlated with an image input from the image input module 10. Even when the image processing apparatus is integrated into an imaging apparatus, the extra-image information input module 20 may be configured as an image reading module, which reads extra-image information from the outside of the imaging apparatus, as a matter of course.

The extra-image information includes imaging parameters, environmental information, space-time information, sensor information, secondary information from the Web, and the like. The imaging parameters include ISO, flash, shutter speed, focal length, F-number, and the like. The environmental information includes sound, temperature, humidity, pressure, and the like. The space-time information includes GPS information, date and time, and the like. The sensor information is information that is obtained from a sensor included in the imaging apparatus that has taken the image, and overlaps the above environmental information and the like. The secondary information from the Web includes weather information and event information, which are obtained based on the time-space information (positional information). As a matter of course, the extra-image information input by the extra-image information input module 20 does not necessarily include all the above information items.

There are cases where the above imaging parameters and time-space information are added as Exif information to an image file. In such a case, the image input module 10 extracts only image data from the image file, and the extra-image information input module 20 extracts the Exif information from the image file.

The operating module 30 stores the images input from the image input module 10 and the extra-image information input from the extra-image information input module 20 in a work area (not shown) of the storage module 40. The operating module 30 performs operation of recognizing a main subject in the image input from the image input module 10, by using the image and the extra-image information stored in the storage module 40, and by using data which is stored in advance in the storage module 40.

The storage module 40 includes a feature value and scene correlation storage module 41, a scene and main-subject correlation storage module 42, and a feature value and subject correlation storage module 43. The feature value and scene correlation storage module 41 is a module which stores correlation between the feature value and the scene. The scene and main-subject correlation storage module 42 stores correlation between the scene information and the main subject that is typical for the scene information. The feature value and subject correlation storage module 43 stores correlation between the feature value and the subject.

The operating module 30 includes an image feature value calculator 31, an extra-image feature value calculator 32, a scene recognition module 33, a main subject recognition module 34, a main subject detector 35, an image divider 36, a main subject probability estimating module 37, and a main subject region detector 38.

The image feature value calculator 31 functions as an image feature value generating module which generates an image feature value that is calculated from the image which is to be recognized and has been input by the image input module 10. The extra-image feature value calculator 32 functions as an extra-image feature value acquiring module which acquires an extra-image feature value obtained from the extra-image information input by the extra-image information input module 20. The scene recognition module 33 recognizes scene information of the image, based on the image feature value acquired by the image feature value calculator 31 and the extra-image feature value acquired by the extra-image feature value calculator 32. The main subject recognition module 34 estimates candidates for the main subject, by using the recognized scene information and the correlation stored in the scene and main-subject correlation storage module 42.

The main subject detector 35 detects a main subject of the image, based on the main subject candidates recognized by the main subject recognition module 34, the image feature value acquired by the image feature value calculator 31, and the correlation stored in the feature value and subject correlation storage module 43.

The image divider 36 divides the image to be recognized, which is input by the image input module 10, into a plurality of regions. The main subject probability estimating module 37 estimates the probability that the region is a part of a main subject, based on the feature value in the region divided by the image divider 36, acquired by the image feature value calculator 31, and the feature value of the main subject detected by the main subject detector 35.

The main subject region detector 38 detects a main subject region on the image to be recognized, which has been input by the image input module 10, based on distribution of the main subject probabilities of the regions, which have been estimated by the main subject probability estimating module 37.

The controller 50 controls operations of the modules in the operating module 30.

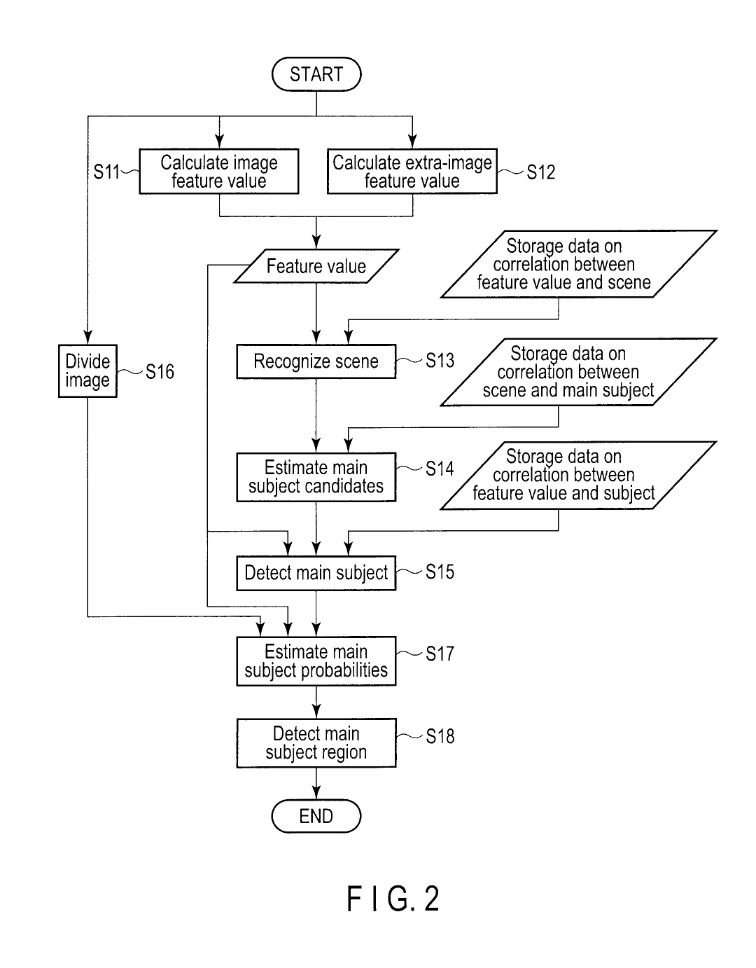

Operation of the operating module 30 will be explained in detail hereinafter with reference to FIG. 2.

First, the image feature value calculator 31 calculates an image feature value from the image input by the image input module 10 (Step S11). The image feature value relating to image Iᵢ is denoted by aᵢ. The subscript i denotes a serial number for identifying the image. The image Iᵢ is a vector that is obtained by arranging pixel values of the image. The image feature value aᵢ is a vector that is obtained by vertically arranging values, which are obtained by various operations from pixel values of the image Iᵢ. For example, the image feature value aᵢ can be obtained by using the method disclosed in Jpn. Pat. Appln. KOKAI Pub. No. 2008-140230.

In parallel with the processing of calculating the image feature value, the extra-image feature value calculator 32 calculates an extra-image feature value from the extra-image information input by the extra-image information input module 20 (Step S12). The extra-image information is denoted by bᵢ. The extra-image feature value bᵢ is a vector obtained by converting various information items which correspond to the image into numerical values, if necessary, or performing operation for the information items, and vertically arranging the numerical values. The details of the extra-image information are as described above.

The controller 50 generates a feature value fᵢ, which is obtained by vertically arranging the calculated image feature value aᵢ and the extra-image feature value bᵢ, as follows:

$${f}_{i} = [ \begin{matrix}{a}_{i} \\ {b}_{i}\end{matrix} ]$$

The controller 50 stores the feature value fᵢ in the work area of the storage module 40. As a matter of course, the operating module 30 may have a function of generating the feature value fᵢ, as a function, instead of the controller 50.

The storage data on correlation between the scene and the main subject, which is stored in the scene and main-subject correlation storage module 42 of the storage module 40, will be explained hereinafter in advance. The storage data on correlation between the scene and the main subject is denoted by “R=[r₁, r₂, . . . , rₘ]”. The reference symbol rⱼ denotes a column vector, which indicates correlation between the scene j and the main subject, as follows:

$${r}_{j} = [ \begin{matrix}{r}_{1} \\ {r}_{2} \\ ⋮ \\ {r}_{k}\end{matrix} ]$$

The reference symbol j denotes a classification number for identifying the scene, and reference symbol m denotes the number of scene candidates which are prepared in advance. For example, the scene candidates are determined in advance, such as “1: swimming in the ocean”, “2: diving”, “3: drinking party”, . . . , and “m: skiing”. The above scene candidates will be used in the following explanation. The storage data on correlation between the scene and the main subject is a vector which is obtained by indicating the main subject probabilities of the respective subjects for each scene. The reference symbol k denotes the number of main subject candidates prepared in advance. For example, the main subject candidates are determined in advance, such as “1: person”, “2: fish”, “3: dish”, . . . , and “k: flower”. The examples of the above main subject candidates will be used in the following explanation. Dimensions of the vector correspond to the respective subjects determined in advance, and elements of the dimensions indicate the main subject possibilities of the subjects. In the case where the main subject possibilities of the subjects in the scene j are “person: 0.6”, “fish: 0.4”, “dish: 0.8”, . . . , and “flower: 0”, rⱼ satisfies the following expression:

$${r}_{j} = [ \begin{matrix}0.6 \\ 0.4 \\ 0.8 \\ ⋮ \\ 0\end{matrix} ]$$

When it is determined whether each subject is the main subject or not in scene j, the probability of each subject is expressed as “0” or “1”.

The scene recognition module 33 performs scene recognition for the image Iᵢ, by using the feature value fᵢ stored in the work area of the storage module 40 (Step S13). The method of scene recognition will be explained later with an example of using the correlation stored in the feature value and scene correlation storage module 41. The scene recognition result for the image Iᵢ is expressed as probabilities of the respective scenes. For example, when the scene recognition result is obtained as the probabilities “swimming in the ocean: 0.9”, “diving: 0.1”, “drinking party: 0.6”, . . . , and “skiing: 0.2”, the following scene recognition result Sᵢ is obtained, as a vector obtained by vertically arranging the probabilities of the scenes:

$${S}_{i} = [ \begin{matrix}0.9 \\ 0.1 \\ 0.6 \\ ⋮ \\ 0.2\end{matrix} ]$$

When it is determined whether each scene corresponds to the scene of the image Iᵢ or not, the probability of each scene is expressed as “1” or “0”.

The main subject recognition module 34 calculates the main subject probability vector “Oᵢ=RSᵢ”, by using the scene recognition result Sᵢ obtained by the scene recognition module 33 for the image Iᵢ and the storage data R on correlation between the scene and the main subject, which is stored in the scene and main-subject correlation storage module 42 (Step S14). The main subject probability vector Oᵢ is a vector which indicates the probabilities that the respective main subject candidates are the main subject. For example, the vector Oᵢ as follows is obtained, the probabilities that the respective main subject candidates are the main subject are “person: 0.7”, “fish: 0.1”, “dish: 0.2”, . . . , and “flower: 0.5”:

$${O}_{i} = [ \begin{matrix}0.7 \\ 0.1 \\ 0.2 \\ ⋮ \\ 0.5\end{matrix} ]$$

Thus, the subject candidate “person” which has the highest probability is recognized as the main subject. The method is not limited to the example of recognizing the subject candidate that has the highest probability as the main subject. When there are any subject candidates which have values close to the probability of the subject candidate that has been recognized as the main subject, a plurality of subject candidates may be recognized as main subjects.

As described above, scene recognition is performed based on the image feature value and the extra-image feature value, and the main subject is recognized based on the recognized scene information. Thereby, it is possible to distinguish the subjects, and recognize the main subject, by taking the scene information into consideration, even when the subjects are difficult to be distinguished from each other only by the image information and the extra-image information of the subjects.

In addition, the accuracy of recognition can be further improved, by further applying a recognition method using the feature value to the main subject that has been recognized based on the above scene recognition result.

Specifically, first, the main subject detector 35 recognizes the main subject by using only the feature value fᵢ stored in the work area of the storage module 40, and then detects the main subject in the image Iᵢ, based on the main subject recognition result and the main subject candidates recognized by the main subject recognition module 34 (Step S15). With respect to the main subject recognition method using only the feature value, an example of using correlation stored in the feature value and subject correlation storage module 43 will be explained.

When the main subject recognition result obtained by using only the feature value is denoted by Dᵢ and the main subject recognition result obtained by using the main subject candidate Oᵢ is denoted by D′ᵢ, the main subject recognition result D′ᵢ is calculated as follows. The main subject recognition results Dᵢ, and D′ᵢ are vectors of the same form as that of the main subject candidate Oᵢ.

D′ᵢ=Oᵢ [symbol] Dᵢ

where the reference symbol [symbol] denotes the product of elements of the matrix.

For example, suppose that the main subject recognition result Dᵢ obtained by using only the feature value and the main subject candidate Oᵢ satisfy the following expressions.

$${D}_{i} = [ \begin{matrix}0.9 \\ 0.1 \\ 0.2 \\ ⋮ \\ 0.9\end{matrix} ] , {O}_{i} = [ \begin{matrix}0.7 \\ 0.1 \\ 0.2 \\ ⋮ \\ 0.5\end{matrix} ]$$

In the above case, in the main subject recognition result Dᵢ obtained by using only the feature value, both the first element and the k-th element have the value “0.9”, and both of them have the maximum probability. Specifically, it cannot be determined whether the subject 1 is the main subject, or the subject k is the main subject.

In comparison with the above case, the main subject recognition result D′ᵢ has the following values:

$${D}_{i}^{′} = [ \begin{matrix}0.63 \\ 0.01 \\ 0.04 \\ ⋮ \\ 0.45\end{matrix} ]$$

Therefore, in the main subject recognition result D′ᵢ, only the first element (the value “0.63”) has the maximum probability, and it can be determined that the subject 1 is the main subject.

Also in this case, when there are any subjects which have a value close to the probability of the subject that has been recognized as the main subject, a plurality of subjects may be recognized as main subjects.

When the present image processing apparatus is incorporated into an imaging apparatus which has an imaging function, such as a digital camera and an endoscope, the detected position of the main subject in the image Iᵢ based on the main subject recognition result described above can be used for a function of the imaging apparatus, such as autofocus.

Thus, the image divider 36 divides the input image stored in the work area of the storage module 40 into a plurality of regions, for example, in a lattice manner (Step S16). Then, the main subject probability estimating module 37 calculates distribution of main subject probabilities, by calculating similarity between the feature value acquired by the image feature value calculator 31 in each of the regions divided by the image divider 36 in a lattice manner, and the feature value of the main subject detected by the main subject detector 35 (Step S17). The feature value of a divided regions A(t) of the image Iᵢ are denoted by fᵢ(t). The average feature value obtained for the main subject detected by the main subject detector 35 is denoted by f(c). The main subject probability distribution J is a vector obtained by arranging main subject probabilities j(t) for the respective regions A(t). The main subject probability j(t) for each region A(t) is calculated as “similarity j(t)=sim(fᵢ(t), f(c))”. For example, the main subject probability j(t) is calculated as a reciprocal number of a distance between vectors of the two feature values fᵢ(t) and f(c).

The main subject region detector 38 detects a main subject region on the image Iᵢ, based on the main subject probability distribution J estimated by the main subject probability estimating module 37 (Step S18). In the step, the main subject region is expressed as a set of main subject region elements A_{O}(t) selected from divided regions A(t) of the image Iᵢ. For example, a threshold value p of the main subject probability is set, and the regions A(t) which satisfy the condition “A(t)>p” are determined as the main subject region elements A_{O}(t).

When the set of the main subject region elements extends over a plurality of connected regions, each connected region is determined as a separate main subject region.

Next, an example of the scene recognition method performed by the scene recognition module 33 will be explained hereinafter.

Suppose that the scene feature value which is added to each image by a person is denoted by wᵢ. The scene feature value is a vector which indicates whether the image corresponds to one of the preset scenes or not. Dimensions of the vector correspond to the respective preset scenes. The value “1” of the element of the dimension indicates that the image corresponds to the preset scene, and the value “0” of the element of the dimension indicates that the image does not correspond to the preset scene. For example, the elements are determined in advance, such as “1: swimming in the ocean”, “2: diving”, “3: drinking party”, . . . , and “m: skiing”. When the scenes of the image Iᵢ are “swimming in the ocean” and “drinking party”, the scene feature value wᵢ has the following values:

$${w}_{i} = [ \begin{matrix}1 \\ 0 \\ 1 \\ ⋮ \\ 0\end{matrix} ]$$

The feature value used for recognition processing for the image Iᵢ is denoted by fᵢ. In addition, the number of the teacher images is denoted by n. The feature value and scene correlation storage module 41 stores a matrix F obtained by arranging feature values used for recognition processing and a matrix W obtained by arranging scene feature values for all the teacher images:

$$F = [ \begin{matrix}{f}_{1}^{T} \\ ⋮ \\ {f}_{n}^{T}\end{matrix} ] , W = [ \begin{matrix}{W}_{1}^{T} \\ ⋮ \\ {W}_{n}^{T}\end{matrix} ]$$

The scene recognition module 33 learns correlation between the feature value fᵢ used for recognition processing and the scene feature value wᵢ, from the data stored in the feature value and scene correlation storage module 41. Specifically, the scene recognition module 33 determines a matrix V for reducing the dimensions of fᵢ, by using canonical correlation analysis (CCA). In canonical correlation analysis, when there are two vector groups fᵢ and wᵢ, V_{F} and V_{W}, with which “uᵢ=V_{F}fᵢ” and “vᵢ=V_{W}wᵢ” have the maximum correlation, are determined. In this example, to effectively reduce the dimensions, V is obtained by extracting the first column to the column of the predetermined number of V_{F}.

The feature value, which is obtained by converting the feature value fᵢ by the matrix V and reducing the dimensions, is denoted by f′ᵢ. Specifically, the expression “f′ᵢ=Vfᵢ” is established. When two images Iₐ and I_{b} are provided, the similarity between the dimension reduction feature values of the images Iₐ and I_{b} is denoted by sim(f′ₐ, f′_{b}). For example, a reciprocal number of the distance between the vectors of the two feature values f′ₐ and f′_{b} is denoted by sim(f′ₐ, f′_{b}).

The scene recognition module 33 calculates the similarity sim(f′ᵢ, f′ₜ) between the input image Iᵢ, for which scene recognition is to be performed, and all the teacher images Iₜ (t=1, . . . , n), and extracts a predetermined number (L) of teacher images Iₚ₍ₖ₎ (k=1, . . . , L), which have the larger similarities from the teacher images. Then, the scene recognition module 33 multiplies the scene feature values wₚ₍ₖ₎ of the extracted teacher images, and normalizes them by dividing them by the extraction number L. A matrix Sᵢ obtained by the calculation is used as a scene recognition result for the input image Iᵢ.

The similarity may be calculated by using the feature value fᵢ, without performing processing of converting the feature value fᵢ by the matrix V and using the feature value f′ᵢ obtained by reducing the dimensions.

The main subject recognition method performed by the main subject detector 35 using only the feature value is the same as the scene recognition method performed by the scene recognition module 33, except that the main subject is recognized instead of the scene, and thus explanation of the method is omitted. As a matter of course, the feature value and subject correlation storage module 43 is used instead of the feature value and scene correlation storage module 41. In addition, the image feature value aᵢ may be used instead of the feature value fᵢ.

As described above, according to the present embodiment, the scene information is used, and thereby it is possible to distinguish separate subjects, which cannot be distinguished only by the image information of the subject and the extra-image information, and recognize the main subject. Specifically, the image processing apparatus according to the present embodiment recognizes the scene information of the image itself, based on the image feature value generated from the image information and the extra-image feature value generated from the extra-image information (for example, the scene is recognized as diving when the date is in the summer, the location is the seashore, and there is water pressure, and the scene is recognized as drinking party when the date is a Friday night and the location is a dimly lit room). When the scene information is recognized, typical main subjects for the scene are limited (for example, main subjects for diving are people and fish, and main subjects for drinking party are limited to people, dishes, and liquor). Thereby, it is possible to distinguish separate subjects, which cannot be distinguished from each other only by the image feature value and the extra-image feature value, by taking the scene information into consideration.

In addition, accuracy of recognition is further improved, by further applying the recognition method using the feature value to the main subject that has been recognized by using the scene information.

Besides, it is possible to detect the position of the main subject in the image, based on the recognition results of the main subject.

The present invention is not limited to the embodiment described above, but can be variously modified within the gist of the present invention as a matter of course.

For example, the above function can be achieved by supplying a program of software which implements the image processing apparatus of the above embodiment, in particular, the function of the operating module 30, to the computer through a storage medium that stores the program, and causing the computer to execute the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus which recognizes a main subject from an image to be recognized, comprising:
an image feature value generating module configured to generate an image feature value calculated from the image to be recognized;
an extra-image feature value acquiring module configured to acquire an extra-image feature value obtained from extra-image information;
a scene recognition module configured to recognize scene information of the image, based on the image feature value and the extra-image feature value;
a scene and main-subject correlation storage module configured to store correlation between scene information and main subjects typical of the respective scene information; and
a main subject recognition module configured to estimate main subject candidates, by using the scene information recognized by the scene recognition module and the correlation stored in the scene and main-subject correlation storage module.

2. The image processing apparatus according to claim 1, further comprising:
a feature value and subject correlation storage module configured to store correlation between feature values and subjects; and
a main subject detector configured to detect the main subject of the image, based on the main subject candidates, the image feature value, and the correlation stored in feature value and subject correlation storage module.

3. The image processing apparatus according to claim 1, wherein the scene and main-subject correlation storage module is configured to store probability that each subject is the main subject for each scene information item.

4. The image processing apparatus according to claim 1, wherein the scene recognition module is configured to recognize probability that the image is the scene is recognized for each of a plurality of scene information items.

5. The image processing apparatus according to claim 1, wherein the main subject recognition module is configured to recognize main subjects of a plurality of types for an image.

6. The image processing apparatus according to claim 2, further comprising:
an image divider configured to divide the image into a plurality of regions;
a main subject probability estimating module configured to estimate main subject probabilities of the regions, based on feature values acquired by the image feature value generating module in the regions divided by the image divider, and a feature value of the main subject detected by the main subject detector; and
a main subject region detector configured to detect a main subject region on the image, based on distribution of the main subject probabilities of the regions.

7. The image processing apparatus according to claim 6, wherein the main subject region detector is configured to detect a plurality of main subject regions for the main subject of one type.

8. An image processing method of recognizing a main subject from an image to be recognized, comprising:
generating an image feature value calculated from the image to be recognized;
acquiring an extra-image feature value obtained from extra-image information;
recognizing scene information of the image, based on the image feature value and the extra-image feature value; and
estimating main subject candidates, by using correlation between scene information items stored in advance and main subjects typical of the scene information items, and the recognized scene information.

9. A recording medium non-transitory storing a program configured to control a computer of an image processing apparatus which recognizes a main subject from an image to be recognized, wherein the recording medium non-transitory stores a program causing the computer to execute:
an image feature value generation step of generating an image feature value calculated from the image to be recognized;
an extra-image feature value acquisition step of acquiring an extra-image feature value obtained from extra-image information;
a scene recognition step of recognizing scene information of the image, based on the image feature value and the extra-image feature value;
a scene and main-subject correlation storing step of storing correlation between scene information and main subjects typical of the respective scene information; and
a main subject recognition step of estimating main subject candidates, by using the scene information recognized by the scene recognition module and the correlation stored at the scene and main-subject correlation storing step.
